(19) United States
(12) Patent Application Publication
(10) Pub. No.: US 2026/0356056 A1
(43) Pub. Date: Nov. 12, 2026

(54) SYSTEM AND METHOD OF TRACKING AND CONTROLLING MATERIAL USAGE IN THE PRODUCTION OF A COMPOSITE ARTICLE

(71) Applicant: Wichita State University, Wichita, KS (US)

(72) Inventors: Waruna Seneviratne, Wichita, KS (US); Tharaka Nandakumara, Wichita, KS (US)

(21) Appl. No.: 19/670,450

(22) Filed: May 7, 2026

Related U.S. Application Data
(60) Provisional application No. 63/801,353, filed on May 7, 2025.

(51) Int. Cl. B29C 70/54; B29C 70/38

(52) U.S. Cl. CPC B29C 70/54; B29C 70/382

(57) ABSTRACT

A system is provided for end-to-end tracking, prediction, and management of defects in composite materials from tape slitting through automated fiber placement (AFP). During slitting, defects such as splices are automatically detected, measured, and stored in a digital thread associated with each spool. This data is used by a virtual lay-up application that simulates material deposition, predicts where defects will occur on the part, and evaluates whether those predicted locations satisfy manufacturing requirements. The AFP in-process inspection system verifies deposition accuracy during lay-up and can trigger recalculations when deviations occur. By linking slitting in-process inspection, spool defect data, virtual lay-up simulation, and AFP in-process validation, the system provides defect detection and the proactive prevention of non-conformances during composites manufacturing.

### CROSS-REFERENCE TO RELATED APPLICATION

This application claims priority to U.S. Provisional Patent Application No. 63/801,353, filed May 7, 2025, which is hereby incorporated by reference in its entirety.

### STATEMENT REGARDING FEDERALLY SPONSORED RESEARCH OR DEVELOPMENT

This invention was made with government support under FA2394-23-C-B0002 awarded by the Air Force Research Laboratory (AFRL) Modeling for Affordable Sustainable Composites (MASC). The government has certain rights in the invention.

### FIELD

The present disclosure generally pertains to the manufacture of composite structures. More specifically, it concerns integrated inspection systems that link tape slitting defect detection with spool-level digital records, virtual lay-up for defect placement prediction and requirement evaluation, and automated fiber placement (AFP) in-process inspection and validation to prevent manufacturing non-conformances.

### BACKGROUND

In highly regulated, complex industries such as aerospace, automotive, and power generation, a defect or malfunction in the final article discovered late in the manufacturing process—or worse, after deployment—can trigger a cascade of costly consequences. The consequences of defects discovered too late include production shutdowns, vehicle recalls, and extensive document review that may take weeks. Sometimes production documentation is found to be missing or incomplete due to human error. Meanwhile, the faulty components might continue moving through production lines, compounding the problem.

Composite manufacturing processes must meticulously account for defects that could compromise structural integrity. The anisotropic nature of composite materials means certain flaws can lead to catastrophic failures if not corrected during manufacturing. One such example of a defect-sensitive process for manufacturing composite articles is Automated Fiber Placement (AFP). The aerospace industry is continually seeking in-process inspection systems and studying the effects of manufacturing defects on the mechanical performance of the composite articles produced with AFP.

It is common for aerospace composite articles to undergo layer-by-layer visual inspection by certified inspectors during fabrication, followed by comprehensive non-destructive testing of the completed structure. Furthermore, many composite materials are sensitive to time, temperature, and humidity during processing which requires them to be stored, manufactured, and cured/consolidated in tightly controlled environments.

When manufacturing composite articles, it is advantageous to automatically record manufacturing conditions. A comprehensive digital record, called a “digital twin,” captures anomalies, physical characteristics, material tracking, personnel involvement, and facility environmental conditions. Ideally, the finished product connects many “digital threads” that collectively constitute the digital twin. It is an aspirational goal of the aerospace industry to create a digital twin that includes digital threads of raw material and weaves the threads through component level, sub-assembly, and final assembly levels. In this vision of full-fledged digital engineering, every final product may have thousands of digital twin components that have embedded information with all the manufacturing details pertaining to the component.

### SUMMARY

According to an aspect of the present disclosure, a method of tracking and controlling material usage in an automated tow lay-up process for production of a composite article is provided. The method includes retrieving a material data set for a tow wound on a premanufactured spool, the material data set including a record of defects indicating lengthwise locations of a plurality of defects along a longitudinal axis of said tow. The method further includes, based on the record of defects and predefined lay-up instructions for the automated tow lay-up process, conducting a virtual lay-up to create a virtual representation of where the plurality of defects would be located on the composite article if said tow were laid up according to the predefined lay-up instructions.

According to other aspects of the present disclosure, the method may include one or more of the following features. The method may further include depositing the tow with an automated tow lay-up machine in accordance with the predefined lay-up instructions and monitoring the tow for defects with an in-process inspection system while depositing the tow. The method may further include calculating a virtual distance between the virtual representations of two adjacent defects in the virtual lay-up and comparing the calculated virtual distance to a manufacturing standard to determine if the distance is conforming to the manufacturing standard. The method may further include determining based on said comparing that the calculated virtual distance is not conforming to the manufacturing standard, and in response, creating adjusted lay-up instructions for producing the composite article and a second virtual representation of where the plurality of defects would be located on the composite article if said tow were laid up according to the adjusted lay-up instructions, wherein said creating the adjusted lay-up instructions includes configuring the adjusted lay-up instructions so that an adjusted virtual distance between the virtual representations of said two adjacent defects in the second virtual representation conforms to the manufacturing standard. Creating the adjusted lay-up instructions may include configuring the adjusted lay-up instructions to discard a portion of the tow so that the plurality of defects will be positioned along the composite article in an arrangement conforming to the manufacturing standard. The plurality of defects may be splices within the tow. The method may further include, based on said monitoring, determining a physical location of each of the defects as the portion of the tow containing the defect is deposited and comparing the determined physical location for each defect to the virtual representation for the respective defect in the virtual lay-up to check for conformity between the physically deposited tow and the virtual lay-up, optionally, wherein said comparing determines conformity between the physically deposited tow and the virtual lay-up in real time. The method may further include, while depositing the tow, updating the virtual lay-up to reflect and adjust for the determined physical location for each defect. Monitoring may include detecting a mark on the tow with the in-process inspection system, the mark denoting a prescribed distance along the longitudinal axis from the defect.

According to another aspect of the present disclosure, a method of tracking defects in a tow winding process is provided. The method includes winding a tow of composite material onto a spool mounted on a tow winding machine, the tow comprising a plurality of defects at spaced apart locations along a longitudinal axis of the tow. The method further includes determining a location of each defect along the longitudinal axis of the tow. The method further includes generating a material data set for the spool including a record of defects comprising the location of each defect along the longitudinal axis of the tow. The method further includes storing the material data for the spool in a non-transitory computer-readable storage medium. The method further includes labeling the spool with a unique machine-readable identifier, wherein the material data set is retrievable by reading the unique machine-readable identifier.

According to other aspects of the present disclosure, the method may include one or more of the following features. The method may further include marking the tow with at least one mark placed at a prescribed distance along the longitudinal axis from at least one of the plurality of defects, wherein the mark is detectable by an in-process inspection system used during an automated tow lay-up process for production of a composite article. Determining the location of each defect may include detecting the defect with a slitter in-process inspection system comprising a camera and an encoder at a winding station, wherein the encoder measures a length of the tow as the tow is wound onto the spool. The camera may include an area-scan camera equipped with a telecentric lens. Detecting the defect may include capturing image frames of the tow and performing image-processing operations on each frame to produce a binarized image, and extracting contours from the binarized image to identify defect indicators. The plurality of defects may include splices, and each splice may include an overlap joining two tow end portions. Determining the location of each defect may be performed in real time during the winding of the tow, rather than as a post-process step. The method may further include applying a series of metered reference marks along the length of the tow at regular intervals. The material data set may further include at least one of: material type, lot number, date of manufacture, material width, spool number, total length, slit date, or out-life tracking information. The unique machine-readable identifier may include at least one of a radio-frequency identification (RFID) tag or a quick response (QR) code. The tow winding machine may include a slitting machine having a plurality of winding stations, and a plurality of tows may be simultaneously wound onto respective spools at the plurality of winding stations.

According to another aspect of the present disclosure, a slitter in-process inspection system for tracking defects in composite tow material is provided. The system includes a slitting machine configured to slit composite material into a plurality of tows. The system further includes a plurality of winding stations, each winding station configured to wind a respective tow onto a spool. The system further includes a camera at each winding station configured to capture images of the tow as the tow is wound onto the spool. The system further includes an encoder at each winding station configured to measure a length of the tow as the tow is wound onto the spool. The system further includes a processor configured to analyze the images captured by the camera to detect defects in the tow and to correlate each detected defect with the length measured by the encoder to determine a location of each defect along a longitudinal axis of the tow. The system further includes a non-transitory computer-readable storage medium storing a material data set for each spool, the material data set including a record of defects comprising the locations of the defects along the longitudinal axis of the tow.

According to other aspects of the present disclosure, the system may include one or more of the following features. The camera may include an area-scan camera equipped with a telecentric lens. The system may further include a programmable logic controller (PLC) configured to collect length data from the encoders at the plurality of winding stations and transmit the length data to a computer running a slitter application. The slitter application may include a user interface including a window displaying real-time length measurements for each winding station. The processor may be configured to perform image-processing operations on each captured image to produce a binarized image and to extract contours from the binarized image to identify defect indicators. The processor may be configured to execute a slitter application to automatically generate a packing list and labels for the spools upon completion of a slitting operation, wherein each label includes a machine-readable code providing access to the material data set for the respective spool. The plurality of winding stations may include eight winding stations configured to simultaneously wind eight tows onto respective spools. The processor may be configured to detect defects comprising at least one of: splices, over-tolerance slit width, under-tolerance slit width, stringers, edge fray, gaps, twisted tow, folded tow, pucker, blister, fiber cluster, resin cluster, foreign object debris, or fuzzballs. The system may further include a marking device configured to apply at least one mark to the tow at a predefined distance along the longitudinal axis from each detected defect, wherein each mark is detectable by an in-process inspection system during an automated tow lay-up process. The non-transitory computer-readable storage medium may include a centralized database, and each spool may be labeled with a unique machine-readable identifier associated with the material data set for the spool in the centralized database.

According to another aspect of the present disclosure, a virtual lay-up system for predicting defect locations in an automated tow lay-up process is provided. The system includes a processor. The system further includes a non-transitory computer-readable storage medium storing processor-executable instructions that, when executed by the processor, cause the processor to retrieve a material data set for at least one spool of tow, the material data set including a record of defects indicating lengthwise locations of defects along a longitudinal axis of the tow. The processor-executable instructions further cause the processor to receive lay-up instructions defining an automated tow lay-up process for producing a composite article. The processor-executable instructions further cause the processor to conduct a virtual lay-up based on the record of defects and the lay-up instructions to create a virtual representation of where the defects would be located on the composite article if the tow were laid up according to the lay-up instructions. The system further includes a display configured to present the virtual representation to an operator.

According to other aspects of the present disclosure, the system may include one or more of the following features. The display may be configured to present a three-dimensional viewport displaying AFP courses overlaid on a CAD model of a tool surface, with predicted defect locations indicated on the AFP courses. The processor-executable instructions may further cause the processor to present a spool selection interface enabling an operator to select spools and assign to corresponding tow numbers, wherein the material data sets are retrieved from a centralized database based on the selected spools. The processor-executable instructions may further cause the processor to calculate a distance between predicted positions of two defects in the virtual representation. The processor-executable instructions may further cause the processor to compare the calculated distance to a minimum permissible distance defined by a manufacturing standard and determine whether the calculated distance conforms to the manufacturing standard. The processor-executable instructions may further cause the processor to automatically flag any predicted defect positions that violate the manufacturing standard. The system may further include a laser projector interface configured to display predicted defect locations directly onto physical tooling. The processor-executable instructions may further cause the processor to present a process specification editor window enabling an operator to upload a process specification defining parameters including a minimum permissible distance between defects. The processor-executable instructions may further cause the processor to conduct updated virtual lay-up simulations during an automated tow lay-up process to account for actual material usage. The processor-executable instructions may further cause the processor to receive material usage data from AFP encoders configured to measure lengths of tows being dispensed during the automated tow lay-up process. The processor-executable instructions may cause the processor to retrieve material data sets for a plurality of spools of tow, each material data set including a record of defects indicating lengthwise locations of defects along a longitudinal axis of the respective tow. The processor-executable instructions may further cause the processor to compare a physical location of a defect detected during the automated tow lay-up process to a predicted location of the defect in the virtual representation, and upon detecting a discrepancy, update the virtual lay-up to reflect the physical location. The processor-executable instructions may further cause the processor to recalculate distances between defects in the updated virtual lay-up and determine whether any recalculated distances result in predicted non-conformances with a manufacturing standard. The processor-executable instructions may further cause the processor to notify an operator when a predicted non-conformance is identified after recalculation. The processor-executable instructions may further cause the processor to generate adjusted lay-up instructions configured to discard a portion of the tow so that defects will be positioned on the composite article in an arrangement conforming to a manufacturing standard.

According to another aspect of the present disclosure, a method of verifying material deposition during an automated tow lay-up process is provided. The method includes retrieving a virtual lay-up comprising predicted locations of defects on a composite article based on a record of defects for at least one spool of tow and predefined lay-up instructions. The method further includes depositing the tow onto a mold with an automated tow lay-up machine. The method further includes detecting a defect in the tow with an in-process inspection system during said depositing. The method further includes determining a physical location of the detected defect on the composite article. The method further includes comparing the physical location of the detected defect to a corresponding predicted location in the virtual lay-up. The method further includes, upon detecting a discrepancy between the physical location and the predicted location, updating the virtual lay-up to reflect the physical location.

According to other aspects of the present disclosure, the method may include one or more of the following features. The method may further include recalculating distances between defects in the updated virtual lay-up and determining whether any recalculated distance is less than a minimum permissible distance defined by a manufacturing standard. The method may further include notifying an operator when a recalculated distance indicates a predicted non-conformance, wherein the notification occurs before the non-conforming material is deposited. The method may further include detecting a mark on the tow with the in-process inspection system, the mark being positioned at a predetermined distance from a defect, and comparing a measured distance from the mark to the defect against an expected distance from the virtual lay-up. The method may further include detecting a metered reference mark on the tow with the in-process inspection system and comparing a cumulative measured tow length to an expected length from the virtual lay-up to verify alignment between the physical lay-up and the virtual lay-up.

According to another aspect of the present disclosure, a system for verifying material deposition during an automated tow lay-up process is provided. The system includes an automated tow lay-up machine configured to deposit tow onto a mold. The system further includes an in-process inspection system configured to detect defects in the tow during deposition and determine physical locations of the detected defects on a composite article. The system further includes a processor. The system further includes a non-transitory computer-readable storage medium storing processor-executable instructions that, when executed by the processor, cause the processor to retrieve a virtual lay-up comprising predicted locations of defects based on a record of defects for at least one spool of tow and lay-up instructions. The processor-executable instructions further cause the processor to receive the physical locations of detected defects from the in-process inspection system. The processor-executable instructions further cause the processor to compare each physical location to a corresponding predicted location in the virtual lay-up. The processor-executable instructions further cause the processor to, upon detecting a discrepancy, update the virtual lay-up to reflect the physical location.

According to other aspects of the present disclosure, the system may include one or more of the following features. The processor-executable instructions may further cause the processor to recalculate distances between defects in the updated virtual lay-up and determine whether any recalculated distance results in a predicted non-conformance with a manufacturing standard. The processor-executable instructions may further cause the processor to notify an operator when a predicted non-conformance is identified, wherein the notification is provided before the non-conforming material is deposited. The in-process inspection system may be further configured to detect marks on the tow positioned at predetermined distances from defects, and the processor-executable instructions may further cause the processor to compare measured distances from detected marks to corresponding defects against expected distances from the virtual lay-up. The system may further include an encoder configured to measure a length of tow being dispensed during deposition, wherein the processor-executable instructions further cause the processor to compare the measured length to an expected length from the virtual lay-up to verify alignment between the physical lay-up and the virtual lay-up.

### BRIEF DESCRIPTION OF THE DRAWINGS

FIG. 1 is a diagram of a method of tracking and controlling material usage in the production of a composite article;

FIG. 2 is a perspective view of a tow slitting machine and a schematic of the slitting in-process inspection system according to an embodiment;

FIG. 3 is a front elevation of a winding encoder and camera in a winding station of a slitting machine according to an embodiment;

FIG. 4 is an image from the slitter in-process inspection system of a defect within a tow in a binarized form;

FIG. 5 is an image from the slitter in-process inspection system of a defect within a tow;

FIG. 6 is a perspective view of a winding encoder in a winding station of a slitting machine according to an embodiment;

FIG. 7 is a schematic of three tows with defects and tow markers;

FIG. 8 is an illustration of a spool of wound tow with a machine-readable code;

FIG. 9 is an image of the main window of the user interface of the slitter application;

FIG. 10 is an image of the station manager window of the user interface of the slitter application;

FIG. 11 is a schematic of an AFP system;

FIG. 12 is a schematic of an eight-tow encoder in a tow storage facility of an automated fiber placement system;

FIG. 13 is a schematic of an exemplary virtual lay-up;

FIG. 14 is a schematic illustrating calculated distances between defects in a virtual lay-up;

FIG. 15 is an image of the layup simulator application user interface;

FIG. 16 is an image of the spool selection window within the layup simulator application;

FIG. 17 is an image of the layup simulator user interface with splices highlighted in the viewport;

FIG. 18 is an image of the list of splice locations within the layup simulator application; and

FIG. 19 is an image of the process specification editor window within the layup simulator application.

Corresponding parts are given corresponding reference characters throughout the drawings.

### DETAILED DESCRIPTION

TABLE 1
BRIEF GLOSSARY OF TERMS

| Abbreviation | Definition |
|---|---|
| AFP | Automated Fiber Placement |
| IAMIS | In-Process AFP Manufacturing Inspection |
| | System |
| AIM | AFP Inspection Module (IAMIS Hardware) |
| ARVIS | Augmented Reality Visualization System |
| LPS | Laser Projection System |
| PCD | Process Control Document |
| PCP | Process Control Parameter |
| ADT | Allowable Defect Threshold |
| RDT | Repairable Defect Threshold |
| dᵢ | Calculated Distance Between Two Defects |
| CaSidᵢ | Calculated Signal for Distance |
| SRAVA | Splice Repetition Avoidance with Virtual |
| | AFP |
| PLC | Programmable Logic Controller |
| UI | User Interface |

The processes of making laminate composite articles in accordance with the present disclosure can broadly be referred to as “tow lay-up processes.” This disclosure refers primarily to automated fiber placement (AFP), but other tow lay-up processes (e.g., automated tape laying) can also be used without departing from the scope of the disclosure. In this disclosure, the term “defects” broadly encompasses all material deviations from ideal specifications, regardless of whether they necessitate repairs.

In this disclosure, a tow is an elongate strip of composite material, typically prepreg (pre-impregnated with resin) used during a tow lay-up process to form a composite part. A tow can be wound onto a spool for use in an AFP process. Tows are sometimes produced by slitting a wider parent roll of composite material into multiple parallel strips using a slitting machine equipped with rotating blades. During slitting, each tow is wound onto an individual spool. A splice is an intentional overlap that joins two ends of a tow into one continuous length. Splices may be present in the parent roll material before slitting, or they may be created during the slitting process when an operator removes a defective section of tow and joins the remaining ends together. Because splices represent localized material discontinuities, manufacturing standards typically impose restrictions on how closely splices may be positioned relative to one another in the finished composite article.

A single AFP process may utilize multiple spools of tows to make one composite article. For example, AFP equipment can be configured to place 8, 16, or 32 tows in one pass (a course), which requires a corresponding number of spools. Multiple courses over the surface of a mold make up a ply, and multiple plies stack upon each other to form a laminate. Manufacturing standards for composite articles typically require minimum distances between certain defect types, such as tow splices. If two defects are placed closer than the minimum permissible distance, the composite article may require rework or be scrapped.

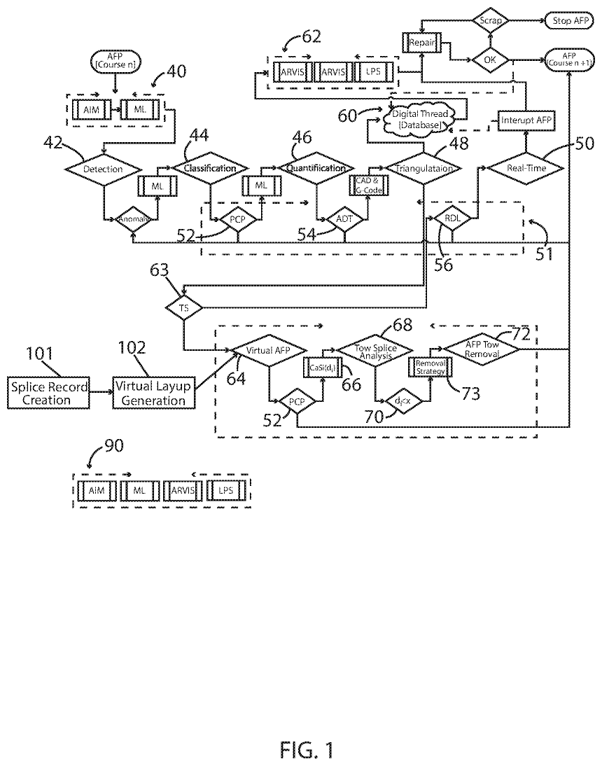

FIG. 1 is a diagram of the process flow of a composite manufacturing process in accordance with the present disclosure. The process includes a splice record creation process 101, a virtual lay-up generation process 102, and an AFP process 103 with in-process inspection 40. The splice record creation process 101 is typically conducted at a first location (e.g., a material supplier's slitting facility) and the virtual lay-up generation 102 and automated tow lay-up process 103 are conducted at a second location (e.g., an AFP facility). The splice record for each spool is associated with the spool via a machine-readable code and centralized database so that the defect location data is available when the spool is loaded for AFP. Although the illustrated system and method are specifically configured for tracking tow splices, other embodiments in the scope of the present disclosure can be configured for tracking other types of defects.

In the splice record creation process 101, a record of the locations of tow splices along the longitudinal axis of a fiber tow is created. In one embodiment, the splice record is created while the tow is being wound onto the core of an AFP spool. The splice record creation process 101 creates a digital twin for each spool that digitally defines the location of each tow splice along the longitudinal axis of the tow wound on the spool. Each spool is given a unique identifier, which is associated with the respective splice record in a database stored in memory.

In the virtual lay-up generation process 102, the spools that will be used in the AFP process 103 are identified by their unique identifiers in order to recall the respective splice records from the database. Based on the locations identified in the splice records and predefined lay-up instructions for the AFP process 103, a virtual model (herein called the virtual lay-up) is created to render how the specific tows will be positioned on the composite part once completed. Essentially, the virtual lay-up virtually unwinds the tow from each spool and virtually places the tow according to the lay-up instructions, creating a virtual representation of the composite article with indications of where the tow splices will be arranged based on their measured positions along the longitudinal axis of the respective tows. The virtual lay-up shows how the splices in the tows will be arranged spatially in the composite part so that the distances separating adjacent splices can be determined in advance.

With this foreknowledge about the expected positions of the tow splices, it is possible to adjust the predefined lay-up instructions for the AFP process 103 before carrying out the AFP process so that the locations of splices conform to manufacturing standards (e.g., no two splices in a given ply are closer than the minimum permissible distance). The current state of the art is limited to detecting splices as defects only during or after material deposition. The virtual lay-up generation process 102, by contrast, allows an operator to predict where tow splices will be positioned in the actual lay-up based on the splice record for each spool of tow. If a non-conformance is predicted, preventative measures can be implemented, such as adjusting the lay-up instructions, rearranging spools, or planning for manufacturing interruption to allow the operator to manually remove a portion of the tow before deposition.

During the AFP process 103, an in-process inspection 40 monitors the tows as they are being laid up. In one or more embodiments, the in-process inspection 40 is conducted by an In-Process AFP Manufacturing Inspection System (IAMIS) described in U.S. Patent Application Publication Nos. 2024/0278510, 2024/0282068, 2025/0078248, and 2025/0308090. The in-process inspection 40 detects 42, classifies 44, quantifies 46, and triangulates 48 defects in fiber tows as they are deposited. When a defect is detected, the system classifies the defect and references the manufacturing standard contained in Process Control Documents (PCD) 52 to determine the tolerance for that defect type. In the quantification step 46, the defect is measured and compared against Allowable Defect Thresholds (ADT) 54. Defects falling below the ADT are considered acceptable without repair.

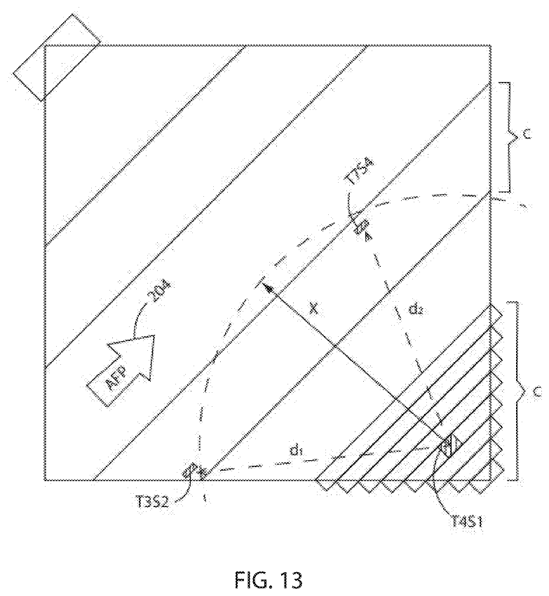

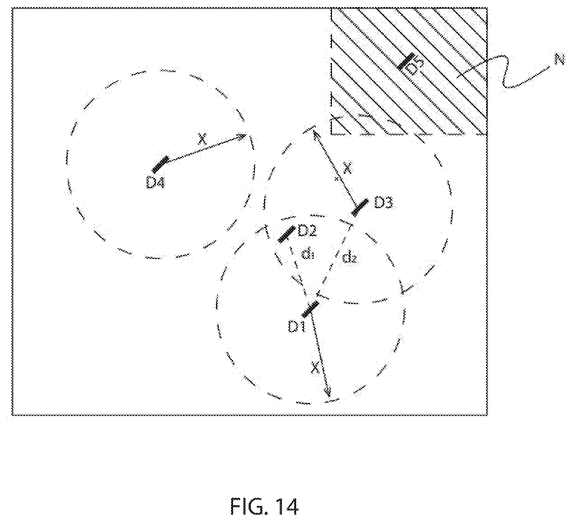

When a splice is detected during the in-process inspection 40, the triangulated location of the splice on the physical composite part is compared with the virtual location in the virtual lay-up. If a discrepancy exists, the virtual lay-up is updated to account for the deviation and recalculate distances between splices. This recalculation may occur multiple times throughout the AFP process 103. The defect is also mapped to a digital twin of the composite article during the triangulation step 48 and evaluated against Repairable Defect Thresholds (RDT) based on its position in the part. RDT defines the boundary between defects that can be repaired; defects exceeding ADT but below RDT may be repaired before use. Some composite articles have no-defect zones where certain defect types are prohibited (e.g., no-splice zones shown as zone N in FIG. 14).

If non-conformances are predicted in the updated virtual lay-up, the AFP operator may be notified to take corrective action before the material is deposited, as shown in removal strategy block 73. Corrective actions may include using different spools, rearranging spools, or modifying the lay-up instructions to discard a portion of tow during deposition.

As those skilled in the art will appreciate from the foregoing introduction, the systems and processes depicted in FIG. 1 create a digital thread of material data from the pre-processing of the tow through the completion of the composite article. Each spool has unique physical characteristics (e.g., splice locations) that persist throughout fabrication. During the AFP process 103, a digital twin of the composite article is constructed, recording all defects and mapping them to the three-dimensional virtual model. Each composite article has unique physical characteristics captured in a digital record that carries through to subsequent processes such as assembly, non-destructive inspection, and the final article.

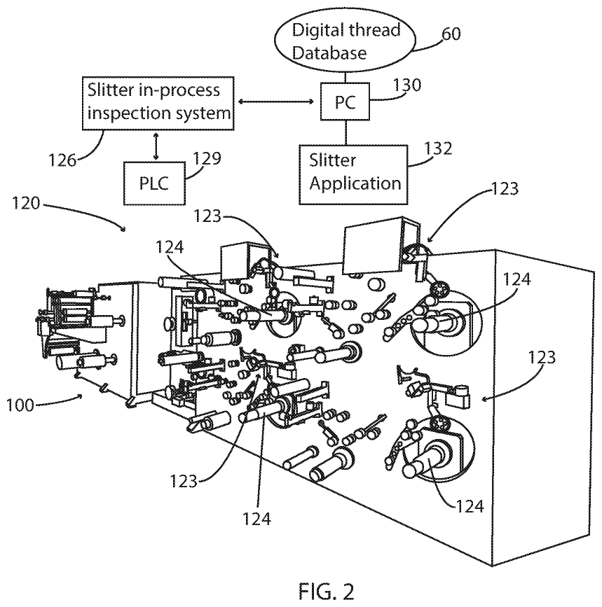

FIGS. 2-10 illustrate an embodiment of the splice record creation process 101 introduced above. In this embodiment, the splice record is created during a slitting and winding operation in which composite material is slit into individual tows 140 and wound onto spools.

Referring to FIG. 2, the slitting machine 120 is configured to slit composite material into individual tows 140 and wind each tow onto a spool while simultaneously detecting and recording the locations of defects along each tow. The slitting machine 120 includes a cutter assembly 100 at one end and a plurality of winding stations 123 at the opposite end. In the illustrated embodiment, the slitting machine 120 includes eight stations 123 where slit tows are independently wound onto respective spools 124.

The slitting process begins with a parent roll of prepreg composite material mounted on an unwind stand. The parent roll may come in various lengths, such as 50 feet or over 600 feet, and may contain one or more splices where the end of one composite sheet has been joined to the end of another. For example, a roll of composite material that is 24 inches wide may be slit into several narrower tows 140, with tow widths often in an inclusive range of from 0.25 inches (6.35 mm) to 0.50 inches (12.7 mm). During slitting, composite material is guided into the cutter assembly 100, which has rotating blades and complementary anvil rollers arranged to slit the material into multiple parallel tows 140 of the desired tow width.

After slitting, the individual tows 140 pass through tension control mechanisms and guide rollers before reaching the winding stations 123. Each tow 140 is simultaneously but independently wound onto a respective spool 124 with precision tensioning systems. Each station 123 is equipped with both an encoder 128 and a camera 134 that together form part of the slitter in-process inspection system 126. As shown in FIG. 6, the encoder 128 at each station 123 tracks the tow length as the tow 140 is being wound. In the embodiment with eight stations, eight encoders monitor eight corresponding tows. The length measured by each encoder 128 is referenced from the start of the tow at the slitting machine; this start point becomes the terminal end of the tow when the material is later unspooled on the AFP machine. When a splice is detected, the distance from the start of the tow 140 to the splice is recorded in the digital thread database 60. All encoders are connected to a PLC 129, which collects length data from all stations and transmits it to a PC 130 running the slitter application 132 via an Ethernet connection. This data is displayed in real time on the slitter application 132 user interface, enabling operators to monitor spool lengths continuously.

The slitter in-process inspection system 126 is configured to detect the locations of defects along the longitudinal axis of each tow, including splices, over/under tolerance slit width, stringers/edge fray, gaps, twisted tow, folded tow, pucker/blister, fiber/resin cluster, foreign object debris, and fuzzballs. Once the slitting process is complete, the spools may be removed and transferred to the AFP facility. The spools may require special shipping and handling, such as sealed packaging and cold storage. Although the slitting machine 120 has been described, any machine capable of winding tow while recording defect locations is within the scope of the present disclosure.

As explained above, two splices often exist because of sheet-to-sheet splices in the parent material. In addition to splices present in the parent roll, new splices may be created during the slitting process itself. When certain defects are detected in the tow, an operator may remove the defective section by cutting it out and joining the remaining ends together, which creates a new splice. The operator typically overlaps one end over the other by roughly 0.50 inches (12.7 mm) and uses a soldering iron or heat gun to make the composite material tacky before applying hand pressure to fuse the ends. Both pre-existing splices from the parent roll and operator-created splices are detected by the slitter in-process inspection system 126 and recorded in the splice record for the spool.

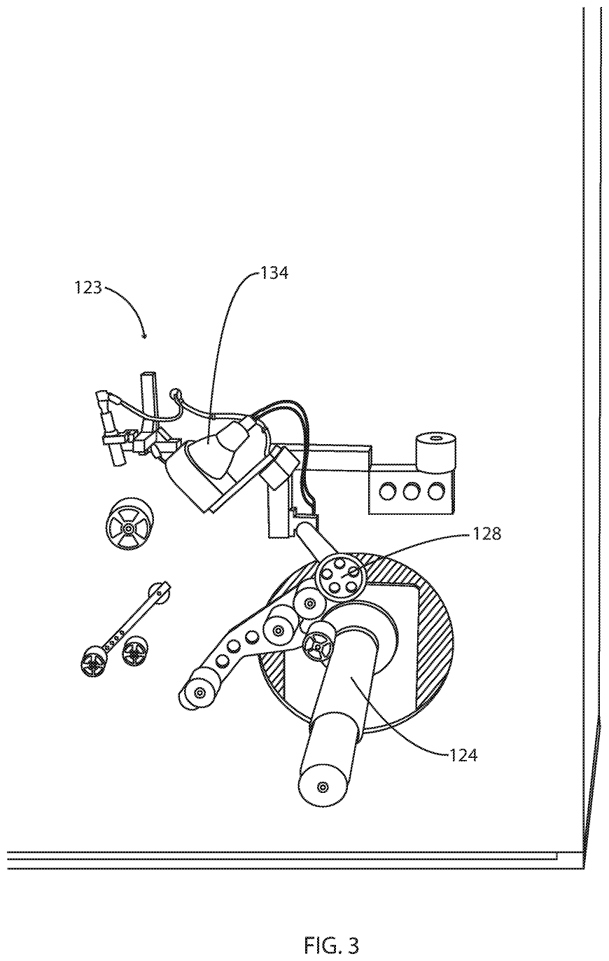

Turning to FIG. 3, in one or more embodiments, each camera 134 is an area-scan camera equipped with a telecentric lens. The telecentric lens minimizes image distortion, enabling precise dimensional measurements of the tow 140 as it passes through the inspection zone. At each station 123, the camera 134 is synchronized with the corresponding encoder 128 so that each captured image frame is correlated with the encoder measurement at the moment of capture. When a defect is detected in an image frame, the system retrieves the encoder measurement associated with that frame to determine the location of the defect along the longitudinal axis of the tow, referenced from the start of the tow at the slitting machine. This frame-by-frame synchronization enables precise defect localization even as the tow moves continuously through the inspection zone at varying speeds.

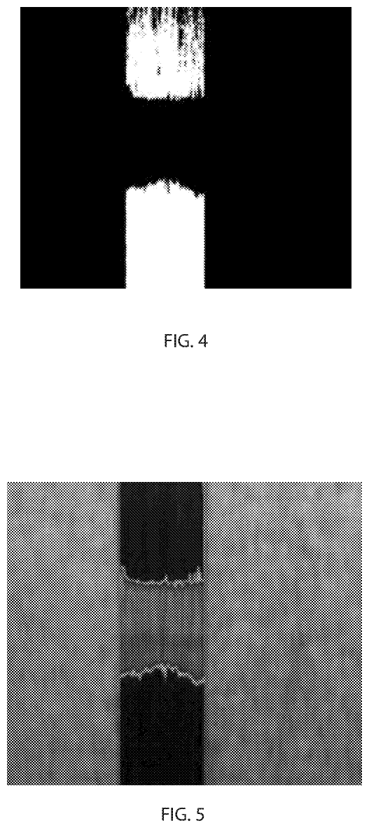

The data captured with the slitter in-process inspection system 126 is analyzed in real time during the slitting operation to identify defects as they occur. In an embodiment, this includes detecting the presence of splices in the material and verifying the width of the slit tow. Each frame captured by the camera 134 undergoes a sequence of image-processing operations (e.g., Gaussian blur, binary thresholding, image morphology) to produce a binarized image as shown in FIG. 4.

From the binarized image, contours are extracted and used to identify contrast-based splice indicators. Because splices typically produce multiple markings across consecutive frames, splice-related detections within a defined frame range are combined to represent a single splice event. The binarized image is also used to generate a rectangular bounding box representing the tow bounds, which enables verification of slit tow width. The detection algorithms use a parameter set that may be adjusted for different material types to account for variations in appearance such as color and reflectivity.

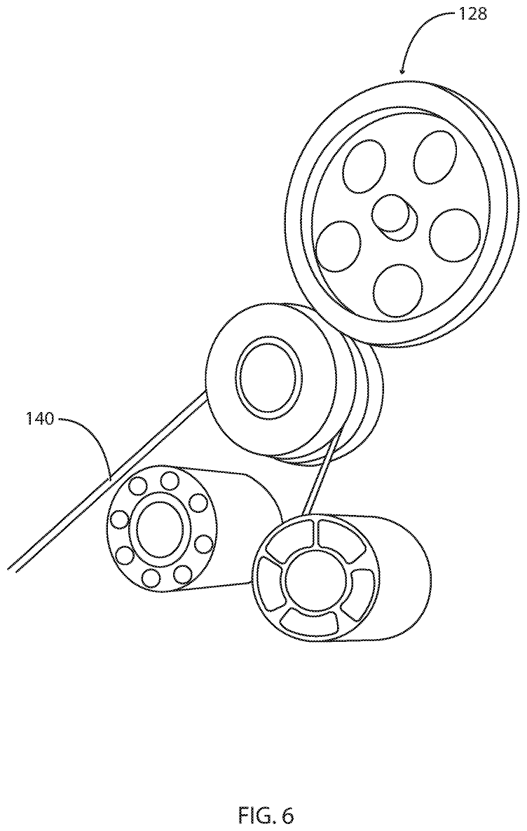

The output image of the slitter in-process inspection system 126 is shown in FIG. 5, displaying a detected splice and a bounding box indicating the tow bounds. Measurement values for defects and tow bounds are determined by calculating pixel dimensions and multiplying by a calibrated pixel-distance value. The resulting detections may be overlaid onto the original full-color image for inspection reporting purposes.

Referring back to FIG. 2, as each splice is detected and measured during the slitting operation, the splice location is transmitted to the digital thread database 60 via the slitter application 132. Over the course of winding a complete spool, the individual splice detections are aggregated into a splice record that documents the location of every splice along the longitudinal axis of the tow. The splice record is one component of a material data set for the spool that is stored in the database and associated with the unique identifier for the spool. Additional material data may include information about other types of defects detected during the winding process (e.g., defect type, defect location), information about the tow material (e.g., material type, lot number, date of manufacture), material width, spool number, total length, number of splices, slit date, and out-life tracking information. In this manner, the splice record creation process 101 produces a complete digital twin for each spool that can be retrieved for use in the virtual lay-up generation process 102.

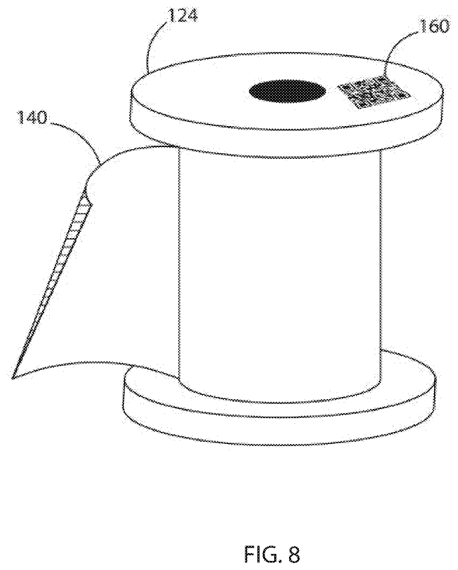

As illustrated in FIG. 8, a machine-readable code 160, which may be a tag incorporating radio-frequency identification (RFID), quick response (QR) code, or similar identification technology, is securely affixed to the spool. The code provides access (e.g., a link) to the material data for the spool. The code and the associated data may be generated automatically by the slitter application 132.

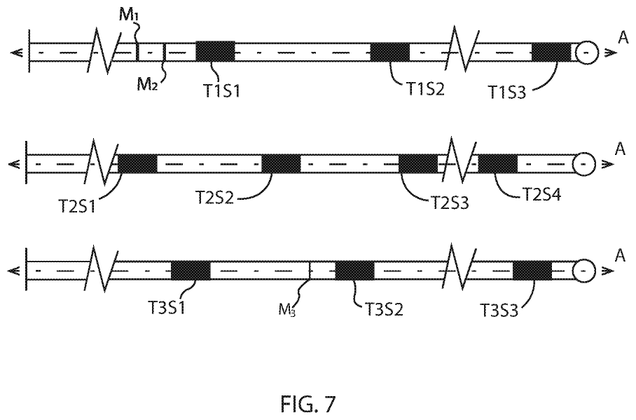

Referring to FIG. 7, three different spools of tow T1, T2, and T3 are illustrated with respective splices along their lengths. The first tow T1 has three splices distributed longitudinally: T1S1, T1S2, and T1S3. The second tow T2 has four splices positioned at various intervals along the length of the tow: T2S1, T2S2, T2S3, and T2S4. The third tow T3 presents three splices at specific locations along the length of the tow: T3S1, T3S2, and T3S3. During the slitting operation, the automated inspection system or the operator records the placement of splices along the longitudinal axis A of each tow. The splice locations are recorded in the material data set that includes the splice record for the respective spool. The material data for the spool is retrievable through scanning a machine-readable code containing the unique identifier for the spool.

At least one mark may be applied to the tow at a predefined distance along the longitudinal axis from each detected splice. The marking is suitably performed during the winding process. In an example, a first mark M1 may be placed 3 feet after the splice and a second mark M2 may be placed 1 foot after the splice. In one or more embodiments, each mark is an indicators that are visually detectable by an in-process inspection system during tow lay-up, e.g., each mark is a color-coded line segment or fluorescent tracer. In certain embodiments, the marks are physical formations such as embossed lines or bumps that can be detected with profilometers during in-process inspection 40. The marks may be applied manually by an operator or automatically in conjunction with an in-process inspection system on the slitting machine 120.

In addition to the splice-adjacent marks M1 and M2, a series of metered reference marks M3 may be applied along the entire length of the tow at regular intervals. The metered marks M3 may be placed at fixed intervals, such as every 10 feet, or at other suitable distances depending on material requirements or machine configuration. The M3 marks may be visually detectable, physically detectable, or both, and may be applied automatically as the tow is wound.

As the tow is unwound during material deposition, the marks M1, M2, and M3 are detected by the in-process inspection system. The splice-adjacent marks M1 and M2 provide notice that a splice will follow after a pre-determined length of tow is deposited. The metered marks M3 allow the AFP system to perform periodic confirmation checks to ensure alignment between the measured tow length and the virtual lay-up plan. These marks provide secondary validation that helps with splice tracking in cases where the physical measurement of the tow deviates from the virtual lay-up, such as when an operator manually removes a portion of the tow. A method of reconciling the virtual lay-up with the actual lay-up will be discussed in further detail below.

In conjunction with the hardware components described above, the slitter application 132 manages spool-level data throughout the slitting process. In an embodiment, the slitter application 132 records the length of each spool and the location of splices. In certain embodiments, the slitter application 132 simultaneously captures data for all spools during the slitting process.

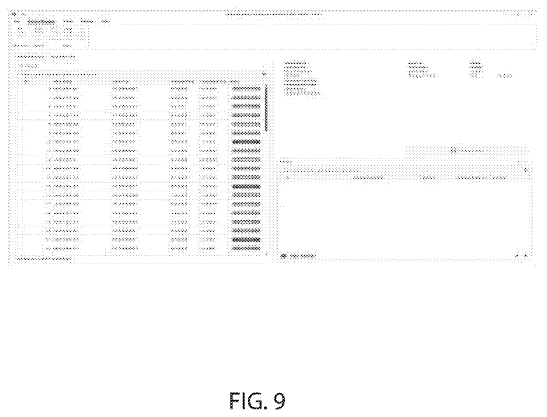

The main window of the UI for the slitter application 132 is shown in FIG. 9. The main window displays all work orders associated with the slitter 120, including the parent roll and status information. When a specific work order is selected, detailed information about that work order appears on the right panel of the window. For completed or paused work orders, the bottom-right section provides information about the processed spools related to that work order. Once slitting is complete, the application automatically generates a packing list and customer labels. All data is stored in a centralized database for traceability. The labels generated for each spool include a QR code for direct access to the corresponding spool data.

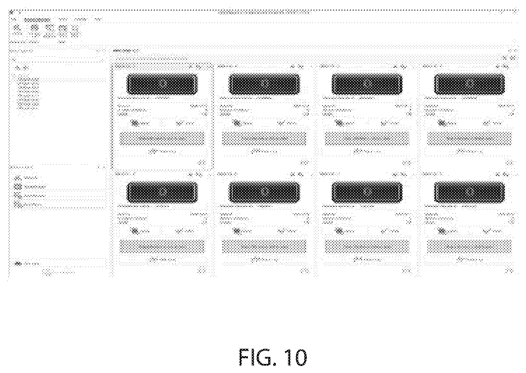

Turning to FIG. 10, a dedicated station-management window of the slitter application 132 displays eight counters, each corresponding to a station on the slitter machine. The station manager shows real-time length measurements of each tow being wound. The operator can individually reset stations, disable unused stations, add splice events to individual or all stations, and push data to the digital thread database 60 upon completion. Work orders requiring more than eight spools may be processed in sequential batches while remaining associated with the same parent roll.

The foregoing description of FIGS. 2-10 illustrates how the splice record creation process 101 produces a complete digital twin for each spool of tow. Each spool leaving the slitting facility carries a machine-readable code that links to a material data set containing the precise locations of all splices and other defects along the longitudinal axis of the tow. This defect location data, which was previously unavailable in composite manufacturing, enables the virtual lay-up generation process 102 and the AFP process 103 described below. When the spools arrive at the AFP facility and are loaded into the AFP system, the material data sets are retrieved and used to predict where defects will be positioned on the composite article before material deposition begins.

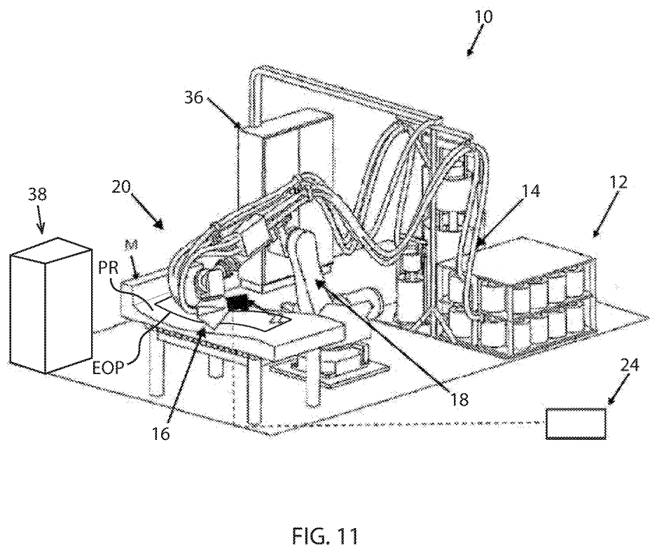

FIG. 11 is an example of a material deposition system, specifically an AFP system 10. The AFP system 10 includes a fiber storage facility 12, a fiber conveyor 14, an AFP head 16, a robot 18, an in-process inspection system 20, a control unit 36, a recycling unit 38, and a controller 24. The fiber storage facility 12 stores one or more spools of fiber tows that can be unwound and dispensed for use in the automated fiber placement process. The fiber conveyor 14 comprises flexible tubes through which fiber tows are conveyed from the fiber storage facility 12 to the AFP head 16. The AFP head 16 is configured to guide and place tows onto a mold M as the robot 18 moves the AFP head 16 along the mold M. The robot 18 provides multi-axis movement capability for positioning the AFP head 16 during material deposition. The recycling unit 38 is positioned adjacent to the mold M and receives material that is deposited outside of the composite article, such as tow portions containing defects that would produce non-conformances.

The AFP system 10 includes a control unit 36 to execute preprogrammed instructions that define an AFP lay-up, herein referred to as lay-up instructions. The lay-up instructions configure the AFP system 10 to form a plurality of plies onto the mold. For each ply, the control unit 36 will direct the AFP system 10 to place a plurality of tows onto the mold such that the tows are arranged parallel and side-by-side in defined fiber orientation.

In the illustrated embodiment, an in-process inspection system 20 is integrated into the AFP head 16. In one non-limiting example, the in-process inspection system 20 is the previously mentioned IAMIS. In general, the in-process inspection system 20 is capable of detecting defects such as gaps, overlaps, splices, twisted or missing tows, foreign object debris (FOD), and cumulative defects. Those defects are saved in a digital twin record for the composite article.

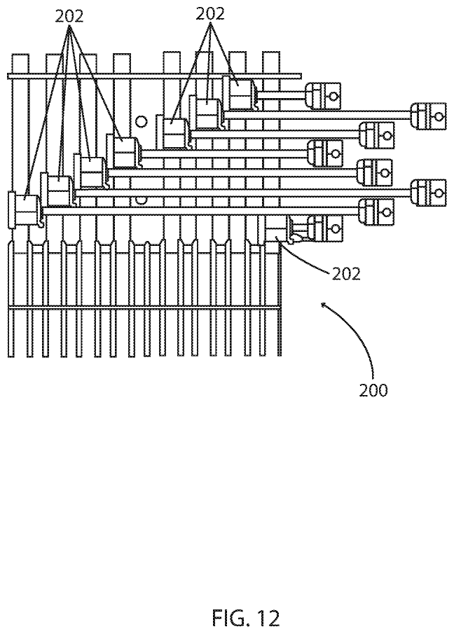

Turning to FIG. 12, the tow storage facility 200 of the AFP system 10 includes a series of AFP encoders 202, with each AFP encoder 202 operatively connected to track an individual tow. In the illustrated embodiment, eight AFP encoders 202 are shown, corresponding to the eight tows that can be simultaneously deposited during a single course of the automated fiber placement process. Each AFP encoder 202 is configured to measure the length of tow being dispensed from each spool as the material is conveyed toward the AFP head 16 during material deposition. The AFP encoders 202 communicate with the in-process inspection system 20 and virtual lay-up software 64 to enable comparison between measured tow lengths and virtual lay-up calculated distances during the deposition process.

FIGS. 13 and 14 illustrate an example virtual lay-up and demonstrate how the virtual lay-up can be used to evaluate whether predicted splice positions conform to manufacturing standards. In the illustrated example, the evaluation is performed using a calculated signal for distance (CaSid) analysis. CaSid analysis computes the distances between predicted splice positions and compares those distances to the minimum permissible distance between splices defined by the manufacturing standard. Although the illustrated example applies CaSid analysis to tow splices, the same predictive compliance analysis may be applied to other types of defects that are detected and recorded during the slitting process. For example, if the slitter in-process inspection system 126 detects and records the locations of fiber clusters, resin clusters, or other material anomalies along the longitudinal axis of the tow, the virtual lay-up generation process 102 can predict where those defects will be positioned on the composite article and evaluate whether the predicted positions conform to manufacturing standards applicable to those defect types.

In FIG. 13, a virtual lay-up illustrates the predicted arrangement of tow splices within a single ply of the composite article. The virtual lay-up is generated by combining the splice records for each spool with the lay-up instructions that define how the AFP system will deposit material. For each tow, the virtual lay-up software virtually unwinds the tow from its spool and virtually places the tow along the programmed course path, using the recorded splice locations to determine where each splice will be positioned on the composite article. In the illustrated example, three splices from three different tows are virtually deposited within the ply: splice T4S1 from the fourth tow, splice T3S2 from the third tow, and splice T7S4 from the seventh tow. The travel direction 204 indicates the direction of AFP head movement during material deposition. Once the splice positions are determined, the virtual lay-up software calculates the distances between adjacent splices. A first defect distance d1 extends between splice T3S2 and splice T4S1. A second defect distance d2 extends between splice T7S4 and splice T4S1. These calculated distances are compared against the minimum defect distance X, which represents the minimum permissible distance between splices according to the applicable manufacturing standard.

The virtual lay-up software calculates the distances between the predicted splice positions T4S1, T3S2, and T7S4 and compares each calculated distance to a minimum permissible distance X. If any calculated distance is less than X, the virtual lay-up application flags the non-conformance and notifies the operator. In the illustrated example, the distance d2 between splices T4S1 and T7S4 is less than the minimum permissible distance X, indicating a predicted non-conformance. To address the predicted non-conformance, the operator may select from several corrective actions, including substituting different spools, rearranging the spool assignments, or modifying the lay-up instructions to automatically discard a portion of the fourth tow or the seventh tow during deposition, thereby repositioning the splices to achieve a conforming distance.

FIG. 14 illustrates the CaSid analysis applied to a virtual lay-up containing multiple defects. In the illustrated example, five defects D1 through D5 are virtually positioned within a ply. Each defect is evaluated against the minimum permissible distance X, represented by a dashed circular boundary surrounding the defect. The CaSid analysis calculates the distance between each pair of adjacent defects, e.g., a first distance d1 between defects D1 and D2, and a second distance d2 between defects D1 and D3, and compares these distances to the minimum permissible distance X. Additionally, the virtual lay-up identifies whether any defect falls within a restricted zone, such as the no-splice zone N. In the illustrated example, defect D5 is positioned within zone N, which would trigger a non-conformance flag. When the CaSid analysis identifies a predicted non-conformance, whether due to insufficient distance between defects or placement within a restricted zone, the system notifies the operator so that corrective action may be taken before material deposition begins.

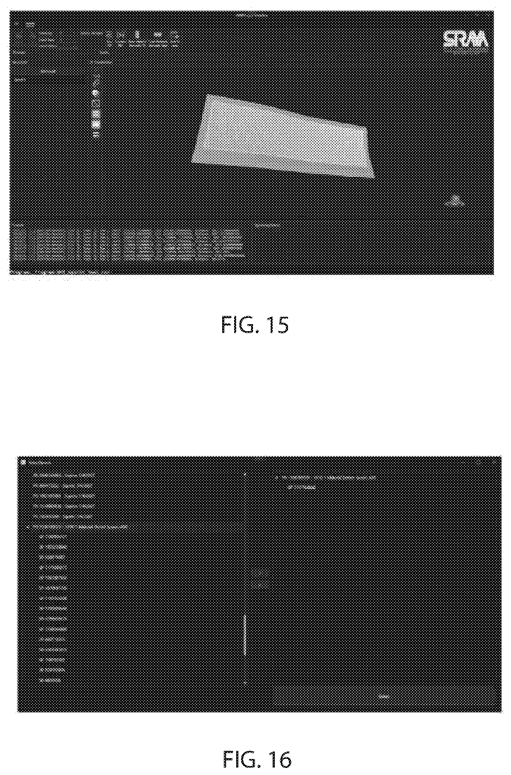

FIGS. 15-19 illustrate an embodiment of the virtual lay-up software 64 implemented as a layup simulator application. The layup simulator performs a virtual AFP layup prior to the physical AFP process to determine the predicted locations of splices on the composite article. The application couples the AFP program with the splice data for the spools selected for the layup and uses this information to compute the predicted placement of each splice on the part. A process specification, which defines parameters such as minimum permissible distance between splices, may also be provided to the application, and any splice groupings or spacing violations relative to the specification are automatically flagged within the application.

Each AFP course is individually loaded and overlaid in a three-dimensional viewport positioned on the CAD model of the AFP tool surface as shown in the layup simulator UI in FIG. 15. This visualization enables operators to view the predicted splice locations within the context of the part geometry.

Turning to FIG. 16, the spool selection window is used by the operator to select the spools that will be used for the layup. The operator assigns each spool to the appropriate tow number on the AFP head. Spool data is retrieved from the centralized database that stores the slitting in-process inspection data. After spool assignment, the virtual lay-up software calculates the length of material used by each tow on every course for each ply. The calculated material distances are combined with the amount of material remaining on each spool, and these two distance values are used to place predicted splice positions on the part.

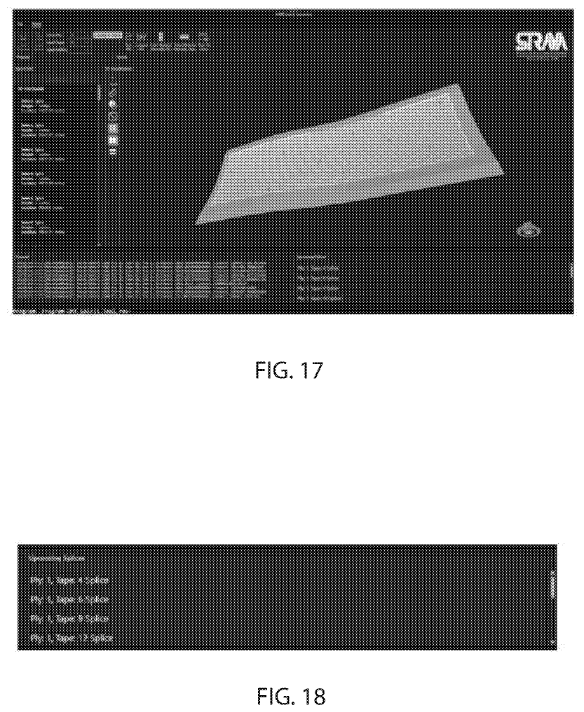

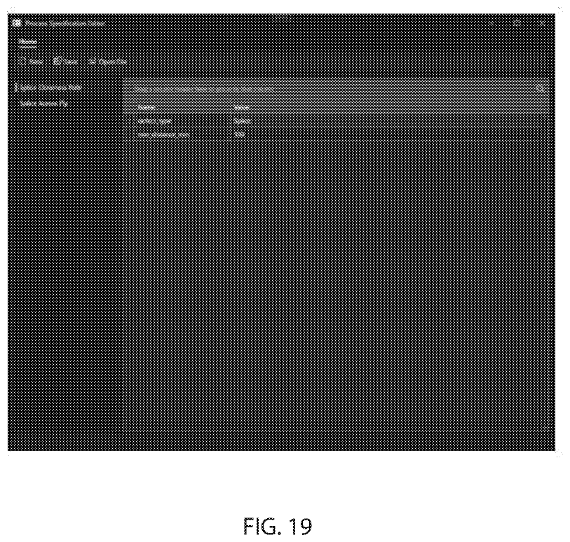

The predicted splice locations are displayed in the viewport of the layup simulator UI as shown in FIG. 17. The layup simulator may also interface with laser projectors to display predicted splice locations directly onto the physical tooling. The operator may select to display splices for a full ply, splices that violate the process specification, or a single splice. FIG. 18 is an example of a list of splice locations displayed in the layup simulator UI that correspond directly to ply numbers and tape numbers. Turning to FIG. 19, a process specification editor window allows operators to upload a process specification and modify the parameters. When the operator uploads a process specification, any predicted splice that violates the specification is automatically flagged.

The foregoing description of FIGS. 15-19 illustrates how the virtual lay-up generation process 102 enables operators to predict splice positions and evaluate conformance to manufacturing standards before the AFP process 103 begins. Once the operator has reviewed the virtual lay-up, addressed any predicted non-conformances, and finalized the spool assignments and lay-up instructions, the AFP process 103 may commence. During the AFP process 103, the virtual lay-up software 64 continues to operate in conjunction with the in-process inspection system 20 to verify that the physical lay-up conforms to the virtual lay-up and to dynamically update the virtual lay-up when deviations are detected.

In general, the layup simulator may conduct updated simulations during the AFP process 103 to account for actual material usage. Material consumption during AFP may deviate from the virtual lay-up due to several factors, including material manually pulled through the AFP head by an operator, material consumed during a repair operation, or material discarded to avoid a predicted non-conformance. The application may read material usage data from the AFP encoders 202, which measure the length of tow being dispensed from each spool, or the operator may manually input updated values when material is consumed outside of normal deposition.

During the AFP process 103, the in-process inspection system 20 works in conjunction with the virtual lay-up software 64 to verify that the physical lay-up conforms to the virtual lay-up. When the in-process inspection system 20 detects a splice during material deposition, the system triangulates the physical location of the splice on the composite article. This physical location is compared to the predicted location for that splice in the virtual lay-up. If the physical location matches the predicted location within an acceptable tolerance, the system confirms that the virtual lay-up remains accurate. If a discrepancy is detected, the virtual lay-up is updated to reflect the actual splice position, and the distances between splices are recalculated to determine whether any non-conformances are now predicted.

The marks M1, M2, and M3 applied during the slitting process provide additional validation checkpoints during the AFP process 103. When the in-process inspection system 20 detects a splice-adjacent mark (M1 or M2), the system knows that a splice will follow after a predetermined length of tow is deposited. The system compares the measured distance from the detected mark to the corresponding splice against the expected distance from the virtual lay-up. This comparison provides early warning if the physical lay-up is deviating from the virtual lay-up. The metered reference marks M3, which are placed at regular intervals along the tow, allow the system to perform periodic calibration checks throughout the deposition process. When an M3 mark is detected, the system compares the cumulative measured tow length to the expected length from the virtual lay-up. If a discrepancy is detected at any checkpoint, the virtual lay-up may be updated to reflect the actual material usage.

In one or more embodiments, when the recalculated distances in the updated virtual lay-up indicate a predicted non-conformance, the system notifies the operator so that corrective action may be taken before the non-conforming material is deposited. Corrective actions during the AFP process 103 may include pausing deposition to allow the operator to manually remove a portion of the tow, modifying the lay-up instructions to automatically discard material into the recycling unit 38, or adjusting the deposition path to reposition the predicted splice location. By continuously comparing the physical lay-up to the virtual lay-up and recalculating distances in real time, the system enables proactive prevention of non-conformances rather than reactive detection after material has been deposited.

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A method of tracking and controlling material usage in an automated tow lay-up process for production of a composite article, the method comprising:
retrieving a material data set for a tow wound on a premanufactured spool, the material data set including a record of defects indicating lengthwise locations of a plurality of defects along a longitudinal axis of said tow; and
based on the record of defects and predefined lay-up instructions for the automated tow lay-up process, conducting a virtual lay-up to create a virtual representation of where the plurality of defects would be located on the composite article if said tow were laid up according to the predefined lay-up instructions.

2. The method of claim 1, further comprising depositing the tow with an automated tow lay-up machine in accordance with the predefined lay-up instructions and monitoring the tow for defects with an in-process inspection system while depositing the tow.

3. The method of claim 1, further comprising calculating a virtual distance between the virtual representations of two adjacent defects in the virtual lay-up; and
comparing the calculated virtual distance to a manufacturing standard to determine if the distance is conforming to the manufacturing standard.

4. The method of claim 3, further comprising determining based on said comparing that the calculated virtual distance is not conforming to the manufacturing standard, and in-response, creating adjusted lay-up instructions for producing the composite article and a second virtual representation of where the plurality of defects would be located on the composite article if said tow were laid up according to the adjusted lay-up instructions,
wherein said creating the adjusted lay-up instructions comprises configuring the adjusted lay-up instructions so that an adjusted virtual distance between the virtual representations of said two adjacent defects in the second virtual representation conforms to the manufacturing standard.

5. The method of claim 4, wherein said creating the adjusted lay-up instructions comprises configuring the adjusted lay-up instructions to discard a portion of the tow so that the plurality of defects will be positioned along the composite article in an arrangement conforming to the manufacturing standard.

6. The method of claim 1, wherein the plurality of defects are splices within the tow.

7. The method of claim 2, further comprising, based on said monitoring, determining a physical location of each of the defects as the portion of the tow containing the defect is deposited and comparing the determined physical location for each defect to the virtual representation for the respective defect in the virtual lay-up to check for conformity between the physically deposited tow and the virtual lay-up, optionally, wherein said comparing determines conformity between the physically deposited tow and the virtual lay-up in real time.

8. The method of claim 7, further comprising, while depositing the tow, updating the virtual lay-up to reflect and adjust for the determined physical location for each defect.

9. The method of claim 2, wherein said monitoring comprises detecting a mark on the tow with the in-process inspection system, the mark denoting a prescribed distance along the longitudinal axis from the defect.

10. A method of tracking defects in a tow winding process, the method comprising:
winding a tow of composite material onto a spool mounted on a tow winding machine, the tow comprising a plurality of defects at spaced apart locations along a longitudinal axis of the tow;
determining a location of each defect along the longitudinal axis of the tow;
generating a material data set for the spool including a record of defects comprising the location of each defect along the longitudinal axis of the tow;
storing the material data for the spool in a non-transitory computer-readable storage medium; and
labeling the spool with a unique machine-readable identifier, wherein the material data set is retrievable by reading the unique machine-readable identifier.

11. The method of claim 10, further comprising marking the tow with at least one mark placed at a prescribed distance along the longitudinal axis from at least one of the plurality of defects, wherein the mark is detectable by an in-process inspection system used during an automated tow lay-up process for production of a composite article.

12. The method of claim 10, wherein said determining the location of each defect comprises detecting the defect with a slitter in-process inspection system comprising a camera and an encoder at a winding station, wherein the encoder measures a length of the tow as the tow is wound onto the spool.

13. The method of claim 12, wherein the camera comprises an area-scan camera equipped with a telecentric lens.

14. The method of claim 12, wherein said detecting the defect comprises capturing image frames of the tow and performing image-processing operations on each frame to produce a binarized image, and extracting contours from the binarized image to identify defect indicators.

15. The method of claim 10, wherein the plurality of defects comprise splices, and wherein each splice comprises an overlap joining two tow end portions.

16. The method of claim 10, wherein said determining the location of each defect is performed in real time during the winding of the tow, rather than as a post-process step.

17. The method of claim 10, further comprising applying a series of metered reference marks along the length of the tow at regular intervals.

18. The method of claim 10, wherein the material data set further comprises at least one of: material type, lot number, date of manufacture, material width, spool number, total length, slit date, or out-life tracking information.

19. The method of claim 10, wherein the unique machine-readable identifier comprises at least one of a radio-frequency identification (RFID) tag or a quick response (QR) code.

20. The method of claim 10, wherein the tow winding machine comprises a slitting machine having a plurality of winding stations, and wherein a plurality of tows are simultaneously wound onto respective spools at the plurality of winding stations.

21-45. (canceled)

46. A method of verifying material deposition during an automated tow lay-up process, the method comprising:
retrieving a virtual lay-up comprising predicted locations of defects on a composite article based on a record of defects for at least one spool of tow and predefined lay-up instructions;
depositing the tow onto a mold with an automated tow lay-up machine;
detecting a defect in the tow with an in-process inspection system during said depositing;
determining a physical location of the detected defect on the composite article;
comparing the physical location of the detected defect to a corresponding predicted location in the virtual lay-up; and
upon detecting a discrepancy between the physical location and the predicted location, updating the virtual lay-up to reflect the physical location.

47. The method of claim 46, further comprising recalculating distances between defects in the updated virtual lay-up and determining whether any recalculated distance is less than a minimum permissible distance defined by a manufacturing standard.

48. The method of claim 47, further comprising notifying an operator when a recalculated distance indicates a predicted non-conformance, wherein the notification occurs before the non-conforming material is deposited.

49. The method of claim 46, further comprising detecting a mark on the tow with the in-process inspection system, the mark being positioned at a predetermined distance from a defect, and comparing a measured distance from the mark to the defect against an expected distance from the virtual lay-up.

50. The method of claim 46, further comprising detecting a metered reference mark on the tow with the in-process inspection system and comparing a cumulative measured tow length to an expected length from the virtual lay-up to verify alignment between the physical lay-up and the virtual lay-up.

51-55. (canceled)
